(19) United States
(12) Patent Application Publication
(10) Pub. No.: US 2003/0058342 A1
(43) Pub. Date: Mar. 27, 2003

(54) Optimal multi-camera setup for computer-based visual surveillance

(75) Inventor: Miroslav Trajkovic, Ossining, NY (US)

Correspondence Address: Corporate Patent Counsel, U.S. Philips Corporation, 580 White Plains Road, Tarrytown, NY, 10591, US

(73) Assignee: Koninklijke Philips Electronics N.V.

(21) Appl. No.: 10/165,089

(22) Filed: Jun. 7, 2002

Related U.S. Application Data
(60) Provisional application No. 60/325,399, filed on Sep. 27, 2001.

(51) Int. Cl. H04N 5/225

(52) U.S. Cl. 348/207.1

(57) ABSTRACT

A measure of effectiveness of a camera's deployment includes the camera's effectiveness in providing image information to computer-vision applications. In addition to, or in lieu of, measures based on the visual coverage provided by the deployment of multiple cameras, the effectiveness of the deployment includes measures based on the ability of one or more computer-vision applications to perform their intended functions using the image information provided by the deployed cameras. Of particular note, the deployment of the cameras includes consideration of the perspective information that is provided by the deployment.

This application claims the benefit of U.S. Provisional Application No. 60/325,399, filed Sep. 27, 2001, Attorney Docket US010482P.

### BACKGROUND OF THE INVENTION

1. Field of the Invention

This invention relates to the field of security systems, and in particular to the placement of multiple cameras to facilitate computer-vision applications.

2. Description of Related Art

Cameras are often used in security systems and other visual monitoring applications. Computer programs and applications are continually being developed to process the image information obtained from a camera, or from multiple cameras. Face and figure recognition systems provide the capability of tracking identified persons or items as they move about a field of view, or among multiple fields of view.

U.S. Pat. No. 6,359,647 “AUTOMATED CAMERA HANDOFF SYSTEM FOR FIGURE TRACKING IN A MULTIPLE CAMERA SYSTEM”, issued Mar. 19, 2002 to Soumitra Sengupta, Damian Lyons, Thomas Murphy, and Daniel Reese, discloses an automated tracking system that is configured to automatically direct cameras in a multi-camera environment to keep a target image within a field of view of at least one camera as the target moves from room-to-room, or region-to-region, in a secured building or area, and is incorporated by reference herein. Other multiple-camera image processing systems are common in the art.

In a multiple-camera system, the placement of each camera affects the performance and effectiveness of the image processing system. Typically, the determination of proper placement of each camera is a manual process, wherein a security professional assesses the area and places the cameras in locations that provide effective and efficient coverage. Effective coverage is commonly defined as a camera placement that minimizes “blind spots” within each camera's field of view. Efficient coverage is commonly defined as coverage using as few cameras as possible, to reduce cost and complexity.

Because of the likely intersections of camera fields of view in a multiple-camera deployment, and the different occulted views caused by obstructions relative to each camera location, the determination of an optimal placement of cameras is often not a trivial matter. Algorithms continue to be developed for optimizing the placement of cameras for effective and efficient coverage of a secured area. PCT Application PCT/US00/40011 “METHOD FOR OPTIMIZATION OF VIDEO COVERAGE”, published as WO 00/56056 on Sep. 21, 2000 for Moshe Levin and Ben Mordechai, and incorporated by reference herein, teaches a method for determining the position and angular orientation of multiple cameras for optimal coverage, using genetic algorithms and simulated annealing algorithms. Alternative potential placements are generated and evaluated until the algorithms converge on a solution that optimizes the coverage provided by the system.

In the conventional schemes that are used to optimally place multiple cameras about a secured area, whether a manual scheme or an automated scheme, or a combination of both, the objective of the placement is to maximize the visual coverage of the secured area using a minimum number of cameras. Achieving such an objective, however, is often neither effective nor efficient for computer-vision applications.

### BRIEF SUMMARY OF THE INVENTION

It is an object of this invention to provide a method and system for determining a placement of cameras in a multiple-camera environment that facilitates computer-vision applications. It is a further object of this invention to determine the placement of additional cameras in a conventional multiple-camera deployment to facilitate computer-vision applications.

These objects and others are achieved by defining a measure of effectiveness of a camera's deployment that includes the camera's effectiveness in providing image information to computer-vision applications. In addition to, or in lieu of, measures based on the visual coverage provided by the deployment of multiple cameras, the effectiveness of the deployment includes measures based on the ability of one or more computer-vision applications to perform their intended functions using the image information provided by the deployed cameras. Of particular note, the deployment of the cameras includes consideration of the perspective information that is provided by the deployment.

### BRIEF DESCRIPTION OF THE DRAWINGS

The invention is explained in further detail, and by way of example, with reference to the accompanying drawings wherein:

FIG. 1 illustrates an example flow diagram of a multi-camera deployment system in accordance with this invention.

FIG. 2 illustrates a second example flow diagram of a multi-camera deployment system in accordance with this invention.

Throughout the drawings, the same reference numerals indicate similar or corresponding features or functions.

### DETAILED DESCRIPTION OF THE INVENTION

This invention is premised on the observation that a camera deployment that provides effective visual coverage does not necessarily provide sufficient image information for effective computer-vision processing. Camera locations that provide a wide coverage area may not provide perspective information; camera locations that provide perspective discrimination may not provide discernible context information; and so on. In a typical ‘optimal’ camera deployment, for example, a regular-shaped room with no obstructions will be allocated a single camera, located at an upper corner of the room, and aimed coincident with the diagonal of the room, and slightly downward. Assuming that the field of view of the camera is wide enough to encompass the entire room, or adjustable to sweep the entire room, a single camera will be sufficient for visual coverage of the room. As illustrated in the referenced U.S. Pat. No. 6,359,647, a room or hallway rarely contains more than one camera, an additional camera being used only when an obstruction interferes with the camera's field of view.

Computer-vision systems often require more than one camera's view of a scene to identify the context of the view and to provide an interpretation of the scene based on the 3-dimensional location of objects within the scene. As such, the placement of cameras to provide visual coverage is often insufficient. Although algorithms are available for estimating 3-D dimensions from a single 2-D image, or from multiple 2-D images from a single camera with pan-tilt-zoom capability, such approaches are substantially less effective or less efficient than algorithms that use images of the same scene from different viewpoints.

Some 2-D images from a single camera do provide for excellent 3-D dimension determination, such as a top-down view from a ceiling-mounted camera, because the image identifies where in the room a target object is located, and the type of object identifies its approximate height. However, such images are notably poor for determining the context of a scene, and particularly poor for typical computer-vision applications, such as image or gesture recognition.

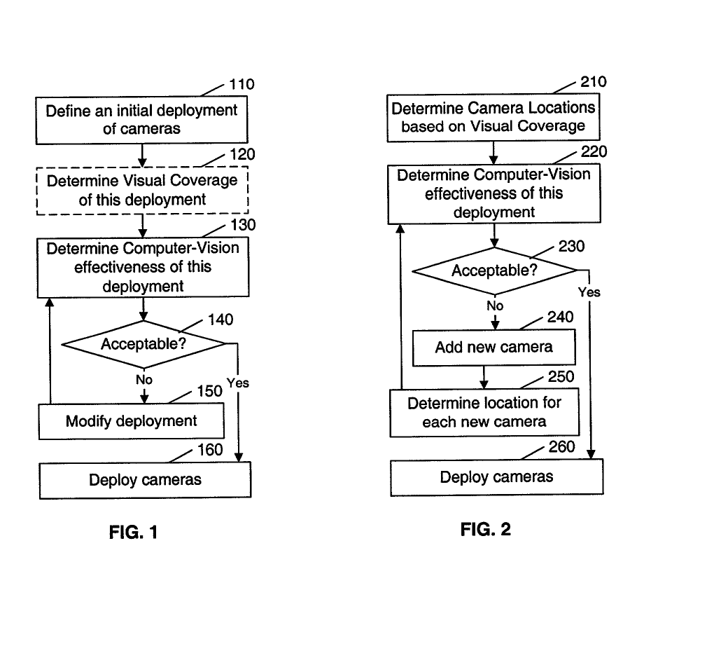

FIG. 1 illustrates an example flow diagram of a multi-camera deployment system that includes consideration of a deployment's computer-vision effectiveness in accordance with this invention. At 110, a proposed initial camera deployment is defined, for example, by identifying camera locations on a displayed floor plan of the area that is being secured. Optionally, at 120, the visual coverage provided by the deployment is assessed, using techniques common in the art. At 130, the “computer-vision effectiveness” of the deployment is determined, as discussed further below.

Each computer-vision application performs its function based on select parameters that are extracted from the image. The particular parameters, and the function's sensitivity to each, are identifiable. For example, a gesture-recognition function may be very sensitive to horizontal and vertical movements (waving arms, etc.), and somewhat insensitive to depth movements. Defining x, y, and z, as horizontal, vertical, and depth dimensions, respectively, the gesture-recognition function can be said to be sensitive to delta-x and delta-y detection. Therefore, in this example, determining the computer-vision effectiveness of the deployment for gesture-recognition will be based on how well the deployment provides delta-x and delta-y parameters from the image. Such a determination is made based on each camera's location and orientation relative to the secured area, using, for example, a geometric model and conventional differential mathematics. Heuristics and other simplifications may also be used. Obviously, for example, a downward pointing camera will provide minimal, if any, delta-y information, and its measure of effectiveness for gesture-recognition will be poor. In lieu of a formal geometric model, a rating system may be used, wherein each camera is assigned a score based on its viewing angle relative to the horizontal.

In like manner, an image-recognition function may be sensitive to the resolution of the image in the x and y directions, and the measure of image-recognition effectiveness will be based on the achievable resolution throughout the area being covered. In this example, a camera on a wall of a room may provide good x and y resolution for objects near the wall, but poor x and y resolution for objects near a far-opposite wall. In such an example, placing an additional camera on the far-opposite wall will increase the available resolution throughout the room, but will be redundant relative to providing visual coverage of the room.

A motion-estimation function that predicts a path of an intruder in a secured area, on the other hand, may be sensitive to horizontal and depth movements (delta-x and delta-z), but relatively insensitive to vertical movements (delta-y), in areas such as rooms that do not provide a vertical egress, and sensitive to vertical movements in areas such as stairways that provide vertical egress. In such an application, the measure of the computer-vision effectiveness will include a measure of the delta-x and delta-z sensitivity provided by the cameras in rooms and a measure of the delta-y sensitivity provided by the cameras in the hallways.

Note that the sensitivities of a computer-vision system need not be limited to the example x, y, and z parameters discussed above. A face-recognition system may be expected to recognize a person regardless of the direction that the person is facing. As such, in addition to x and y resolution, the system will be sensitive to the orientation of each camera's field of view, and the effectiveness of the deployment will be dependent upon having intersecting fields of view from a plurality of directions.

The assessment of the deployment's effectiveness is typically a composite measure based on each camera's effectiveness, as well as the effectiveness of combinations of cameras. For example, if the computer-vision application is sensitive to delta-x, delta-y, and delta-z, the relationship of two cameras to each other and to the secured area may provide sufficient perspective information to determine delta-x, delta-y, and delta-z, even though neither of the two cameras provides all three parameters. In such a situation, the deployment system of this invention is configured to “ignore” the poor scores that may be determined for an individual camera when a higher score is determined for a combination of this camera with another camera.

These and other methods of determining a deployment's computer-vision effectiveness will be evident to one of ordinary skill in the art in view of this disclosure and in view of the particular functions being performed by the computer-vision application.

In a preferred embodiment, if the particular computer-vision application is unknown, the deployment system is configured to assume that the deployment must provide a proper x, y, and z coordinates for objects in the secured area, and measures the computer-vision effectiveness in terms of the perspective information provided by the deployment. As noted above, this perspective measure is generally determined based on the location and orientation of two or more cameras with intersecting fields of view in the secured area.

At 140, the acceptability of the deployment is assessed, based on the measure of computer-vision effectiveness, from 130, and optionally, the visual coverage provided by this deployment, from 120. If the deployment is unacceptable, it is modified, at 150, and the process 130-140 (optionally 120-130-140) is repeated until an acceptable deployment is found. The modification at 150 may include a relocation of existing camera placements, or the addition of new cameras to the deployment, or both.

The modification at 150 may be automated, or manual, or a combination of both. In a preferred embodiment, the deployment system highlights the area or areas having insufficient computer-vision effectiveness, and suggests a location for an additional camera. Because the initial deployment 110 will typically be designed to assure sufficient visual coverage, it is assumed that providing an additional camera is a preferred alternative to changing the initial camera locations, although the user is provided the option of changing these initial locations. Also, this deployment system is particularly well suited for enhancing existing multi-camera systems, and the addition of a camera is generally an easier task than moving a previously installed camera.

FIG. 2 illustrates a second example flow diagram of a multi-camera deployment system in accordance with this invention. In this embodiment, the camera locations are determined at 210 in order to provide sufficient visual coverage. This deployment at 210 may correspond to an existing deployment that had been installed to provide visual coverage, or it may correspond to a proposed deployment, such as provided by the techniques disclosed in the above referenced PCT Application PCT/US00/40011, or other automated deployment processes common in the art.

The computer-vision effectiveness of the deployment is determined at 220, as discussed above with regard to block 130 of FIG. 1. At 230, the acceptability of the deployment is determined. In this embodiment, because the initial deployment is explicitly designed to provide sufficient visual coverage, at 210, the acceptability of the deployment at 230 is based solely on the determined computer-vision effectiveness from 220.

At 240, a new camera is added to the deployment, and at 250, the location for each new camera is determined. In a preferred embodiment of this invention, the particular deficiency of the existing deployment is determined, relative to the aforementioned sensitivities of the particular computer-vision application. For example, if a delta-z sensitivity is not provided by the current deployment, a ceiling-mounted camera location is a likely solution. In a preferred embodiment, the user is provided the option of identifying areas within which new cameras may be added and/or identifying areas within which new cameras may not be added. For example, in an external area, the location of existing poles or other structures upon which a camera can be mounted will be identified.

Note that, in a preferred embodiment of this invention, the process 250 is configured to re-determine the location of each of the added cameras, each time that a new camera is added. That is, as is known in the art, an optimal placement of one camera may not correspond to that camera's optimal placement if another camera is also available for placement. Similarly, if a third camera is added, the optimal locations of the first two cameras may change.

In a preferred embodiment, to ease the processing task in a complex environment, the secured area is partitioned into sub-areas, wherein the deployment of cameras in one sub-area is virtually independent of the deployment in another sub-area. That is, for example, because the computer-vision effectiveness of cameras that are deployed in one room is likely to be independent of the computer-vision effectiveness of cameras that are deployed in another room that is substantially visually-isolated from the first room, the deployment of cameras in each room is processed as an independent deployment process.

The foregoing merely illustrates the principles of the invention. It will thus be appreciated that those skilled in the art will be able to devise various arrangements which, although not explicitly described or shown herein, embody the principles of the invention and are thus within the spirit and scope of the following claims.

I claim:

1. A method of deploying cameras in a multi-camera system, comprising:
determining a measure of effectiveness based at least in part on a measure of expected computer-vision effectiveness provided by a deployment of the cameras at a plurality of camera locations, and
determining whether the deployment is acceptable, based on the measure of effectiveness of the deployment.

2. The method of claim 1, further including
modifying one or more of the plurality of camera locations to provide an alternative deployment,
determining a second measure of effectiveness, based at least in part on the alternative deployment, and
determining whether the alternative deployment is acceptable, based on the second measure of effectiveness.

3. The method of claim 1, further including
modifying the deployment by adding one or more camera locations to the plurality of camera locations to provide an alternative deployment,
determining a second measure of effectiveness, based at least in part on the alternative deployment, and
determining whether the alternative deployment is acceptable, based on the second measure of effectiveness.

4. The method of claim 1, wherein
determining the measure of effectiveness is further based at least in part on a measure of expected visual coverage provided by the deployment of the cameras at the plurality of camera locations.

5. The method of claim 1, wherein
the measure of computer-vision effectiveness is based on a measure of perspective provided by the deployment.

6. The method of claim 1, further including
deploying the cameras at the plurality of camera locations.

7. A method of deploying cameras in a multi-camera system, comprising:
determining a first deployment of the cameras at a plurality of camera locations based on an expected visual coverage provided by the deployment,
determining a measure of expected computer-vision effectiveness provided by the first deployment of the cameras at the plurality of camera locations, and
determining a second deployment of cameras based on the first deployment and the measure of expected computer-vision effectiveness.

8. The method of claim 7, wherein
the second deployment includes the plurality of camera locations of the first deployment and one or more additional camera locations that provide a higher measure of expected computer-vision effectiveness than the first deployment.

9. The method of claim 7, wherein
the measure of expected computer-vision effectiveness includes a measure of perspective provided by the first deployment.

10. The method of claim 7, further including
deploying the cameras according to the second deployment.

11. A computer program that, when operated on a computer system, causes the computer system to effect the following operations:
determine a measure of effectiveness based at least in part on a measure of expected computer-vision effectiveness provided by a deployment of cameras at a plurality of camera locations, and
determine whether the deployment is acceptable, based on the measure of effectiveness of the deployment.

12. The computer program of claim 11, wherein the computer program further causes the computer system to:
modify one or more of the plurality of camera locations to provide an alternative deployment,
determine a second measure of effectiveness, based at least in part on the alternative deployment, and
determine whether the alternative deployment is acceptable, based on the second measure of effectiveness.

13. The computer program of claim 11, wherein the computer program further causes the computer system to:
modify the deployment by adding one or more camera locations to the plurality of camera locations to provide an alternative deployment,
determine a second measure of effectiveness, based at least in part on the alternative deployment, and
determine whether the alternative deployment is acceptable, based on the second measure of effectiveness.

14. The computer program of claim 11, wherein
the computer system further determines the measure of effectiveness based at least in part on a measure of expected visual coverage provided by the deployment of the cameras at the plurality of camera locations.

15. The computer program of claim 11, wherein
the measure of computer-vision effectiveness is based on a measure of perspective by the deployment.
